(19) United States
(12) Patent Application Publication
(10) Pub. No.: US 2026/0365190 A1
(43) Pub. Date: Nov. 19, 2026

(54) CENTRAL CONTROL UNIT AND INTERACTING CONTROL DEVICE FOR AT LEAST ONE MOTORIZED BRAKING, DRIVING, AND/OR STEERING DEVICE OF A VEHICLE

(71) Applicant: Robert Bosch GmbH, Stuttgart (DE)

(72) Inventors: Martin Marquart, Ludwigsburg (DE); Florian Haag, Ellhofen (DE); Nikolas Loeffelmann, Dielheim (DE)

(21) Appl. No.: 19/653,213

(22) Filed: Apr. 21, 2026

(30) Foreign Application Priority Data
Apr. 22, 2025 (DE) 10 2025 115 425.2

(51) Int. Cl. B60W 50/06; B60W 10/08; B60W 10/18; B60W 10/20; B60W 50/02

(52) U.S. Cl. CPC B60W 50/06; B60W 10/08; B60W 10/18; B60W 10/20; B60W 50/0205

(57) ABSTRACT

A control apparatus, an interacting control device, and a method for operating at least one motorized braking, driving and/or steering device of a vehicle. The method includes defining actuating signals for an electric motor of the motorized braking, driving and/or steering device, according to a specified cascade sequence, using a central control unit of the vehicle, outputting an output signal including at least one of the defined actuating signals from the central control unit to a control device of the motorized braking, driving and/or steering device, reading out and/or defining the actuating signals for the electric motor of the motorized braking, driving and/or steering device according to the specified cascade sequence, using the control device, taking into account the output signal output by the central control unit, and outputting at least one motor control signal to the electric motor, using the control device.

### FIELD

The present disclosure relates to a central control unit for interacting with at least one control device for at least one motorized braking, driving and/or steering device of a vehicle, and to a control device for at least one motorized braking, driving and/or steering device of a vehicle. The present disclosure also relates to a control system for at least one motorized braking, driving and/or steering device of a vehicle and to a motorized braking, driving and/or steering device for a vehicle. Furthermore, the present disclosure relates to a method for operating at least one motorized braking, driving and/or Steering device of a vehicle.

### BACKGROUND INFORMATION

Conventional control strategies for operating a braking system of a vehicle are described, for example, in German Patent Application Nos. DE 10 2018 221 815A1 , DE 10 2020 202 477 A1, DE 10 2020 212 789 A1 and DE 10 2022 105 729A1 .

### SUMMARY

The present disclosure provides a central control unit for interacting with at least one control device for at least one motorized braking, driving and/or steering device of a vehicle, a control device for at least one motorized braking, driving and/or steering device of a vehicle, a control system for at least one motorized braking, driving and/or steering device of a vehicle, a motorized braking, driving and/or steering device for a vehicle, and a method for operating at least one motorized braking, driving and/or steering device of a vehicle.

According to an example embodiment of the present disclosure, a central control unit is provided for interacting with at least one control device for at least one motorized braking, driving and/or steering device of a vehicle,
wherein the central control unit is designed and/or programmed such that:
at least two actuating signals for an electric motor of the motorized braking, driving and/or steering device can be defined by means of the central control unit, taking into account at least one provided braking, driving and/or steering request signal from at least one sensor of the vehicle and/or at least one automatic system of the vehicle, according to a specified cascade sequence, such that each actuating signal in the cascade sequence is defined taking into account the at least one braking, driving and/or steering request signal and/or the at least one preceding actuating signal in the cascade sequence, and
an output signal comprising at least one of the defined actuating signals can be output to the control device by means of the central control unit.

The present disclosure provides advantageous possibilities for allowing/simplifying the offloading of functions of a control device used to control an electric motor of a motorized braking, driving and/or steering device of a vehicle to a central control unit of the particular vehicle. This enables development of the functions on the particular central control unit, in particular by better adapting the execution of functions of various motorized braking, driving and/or steering devices of the particular vehicle to one another. Furthermore, the use of the present disclosure allows functional development on the central control unit of the particular vehicle, which is independent of functional development on the at least one control device interacting with the central control unit. The present disclosure thus contributes significantly to the improvement of the control and resulting operation of the at least one motorized braking, driving and/or steering device of the vehicle using it.

A further advantage of the present disclosure is that it can be implemented by means of relatively simple programming/reprogramming of the particular central control unit and of the at least one control device interacting therewith.

Therefore, using the present disclosure is not/is hardly associated with any additional costs.

In an advantageous example embodiment, the control device comprises a storage unit and is designed and/or programmed such that each actuating signal read out from the output signal or defined by means of the control device can be stored on the storage apparatus via a parameter. This allows the selection of relevant actuating signals via an advantageous system mode management.

Preferably, the control device is additionally designed and/or programmed such that at least one specified monitoring algorithm can be executed by means of the control device, by means of which it can be determined, for at least one of the actuating signals read out from the output signal or defined by means of the control device, whether the particular actuating signal is a faulty signal. The embodiment of the control device described here can therefore also be used for the advantageous monitoring of the read-out and/or defined actuating signals.

Preferably, the control device is also designed and/or programmed such that, if the at least one monitoring algorithm determines a number of actuating signals of the cascade sequence as faulty signals and this number is greater than or equal to a specified maximum number, the at least one motor control signal can be output to the electric motor of the motorized braking, driving and/or steering device by means of the control device, taking into account a specified bridging program. In the embodiment of the control device described here, a functional structure is thus permanently stored by means of the bridging program, which structure can be used in the event of a number of faulty signals greater than or equal to the maximum number, so that the vehicle equipped with the embodiment of the control device described here can still be braked, driven and/or steered at least temporarily. This contributes to a significant improvement in the safety standard of the vehicle using the embodiment of the control device described here.

Alternatively, the control device can also be designed and/or programmed such that each signal determined as a faulty signal by means of at least one monitoring algorithm can be replaced by a specified substitute signal. The development of the control device described here can also ensure that the motorized braking, driving and/or steering device controlled by means of the control device can still be operated, at least temporarily, such that the vehicle equipped with the control device can at least still be reliably brought to a standstill. In this way, too, the safety standard of the vehicle using the embodiment of the control device described here is significantly increased.

The advantages described above are also ensured in a control system for at least one motorized braking, driving and/or steering device of a vehicle having such a central control unit and at least one corresponding control device.

A motorized braking, driving and/or steering device for a vehicle having a corresponding control device also produces the advantages described above.

Furthermore, carrying out a corresponding method for operating at least one motorized braking, driving and/or steering device of a vehicle also creates the advantages described above. It is expressly pointed out that the method for operating at least one motorized braking, driving and/or steering device of a vehicle can also be developed according to the embodiments of the control device explained above.

Preferably, when the method is carried out, the output signal is output from the central control unit to the control device of the motorized braking, driving and/or steering device via bus communication. The advantages of bus communication can thus also be used for the interaction of the central control unit and the at least one control device.

### BRIEF DESCRIPTION OF THE DRAWINGS

Further features and advantages of the present disclosure will be explained in the following with reference to the figures.

FIGS. 1A and 1B are schematic representations of example embodiments of the central control unit and of the at least one control device interacting therewith.

FIG. 2 is a flowchart for explaining an example embodiment of the method for operating at least one motorized braking, driving and/or steering device of a vehicle.

### DETAILED DESCRIPTION OF EXAMPLE EMBODIMENTS

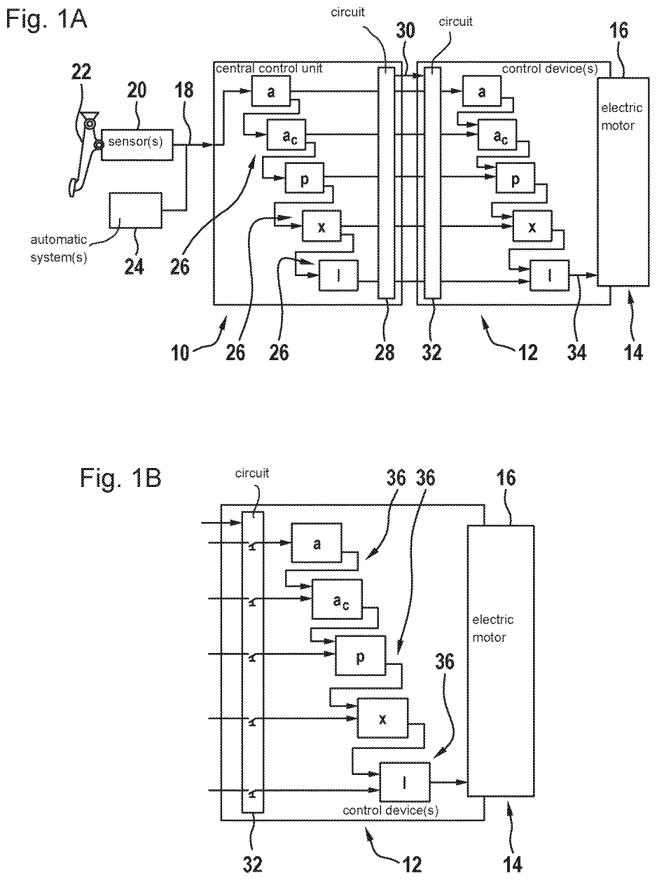

FIGS. 1A and 1B are schematic representations of embodiments of the central control unit and of the at least one control device interacting therewith.

The central control unit 10 shown schematically in FIG. 1A can interact with at least one control device 12 of at least one (only partially shown) motorized braking, driving and/or steering device 14 of a vehicle/motor vehicle. It should be noted that the usability of the central control unit 10 and the at least one control device 12 is not limited to any specific vehicle type/motor vehicle type of the vehicle/motor vehicle equipped with the at least one motorized braking, driving and/or steering device 14.

A plurality of different vehicle components can also be used for the at least one motorized braking, driving and/or steering device 14, of which only its electric motor 16 is shown in FIG. 1A. The term “the at least one motorized braking, driving and/or steering device 14” can mean (almost) any vehicle component which has its (own) electric motor 16 and by means of which the vehicle equipped therewith can be braked, driven and/or steered. The at least one motorized braking, driving and/or steering device 14 can be, for example, a motorized brake pressure building device, an electromechanical brake (EMB), an electric drive motor, an injection valve device of an internal combustion engine, and/or a steering system. Specifically, a motorized brake pressure building device can be a BWA (brake-by-wire) device, an IPB (integrated power brake) device, an electromechanical brake booster (iBooster) that can be or is positioned upstream of a master brake cylinder of a hydraulic braking system, and/or at least one pump of a hydraulic braking system (such as ESP) equipped with a common pump motor. However, the examples listed here of the at least one motorized braking, driving and/or steering device 14 are not to be interpreted as exhaustive.

By means of the central control unit 10, at least one provided braking, driving and/or steering request signal 18 can be evaluated. The at least one braking, driving and/or steering request signal 18 can, for example, be output by at least one sensor 20 of the vehicle to the central control unit 10. FIG. 1A shows, merely by way of example, a sensor 20 attached to a brake pedal 22, such as a rod travel sensor and/or a driver brake force sensor, as an example of the at least one sensor 20. However, the term “the at least one sensor 20” can mean any vehicle sensor system by means of which a braking request from the driver, an acceleration request from the driver and/or a steering request from the driver can be detected and output as a corresponding braking, driving and/or steering request signal 18. Alternatively, the at least one braking, driving and/or steering request signal 18 can also be output to the central control unit 10 by at least one automatic system 24 of the vehicle, by means of which the vehicle can be braked, accelerated and/or steered autonomously. The at least one automatic system 24 can be, for example, a driver assistance system, such as specifically adaptive cruise control, and/or an autonomous driving automatic system.

The central control unit 10 is designed and/or programmed such that at least two actuating signals 26 for the electric motor 16 of the motorized braking, driving and/or steering device 14 can be or are defined by means of the central control unit 10, taking into account the at least one provided braking, driving and/or steering request signal 18, according to a specified cascade sequence. By means of the design and/or programming of the central control unit 10, it is ensured that each actuating signal 26 in the cascade sequence is defined taking into account the at least one braking, driving and/or steering request signal 18 and/or the at least one preceding actuating signal 26 in the cascade sequence. In the example shown in FIG. 1A, the central control unit 10 uses, for example, the braking, driving and/or steering request signal 18 output by the sensor 20 of the brake pedal 22 to successively define a target vehicle deceleration a, a target vehicle deceleration ac corrected by a specified offset, a pedal position p of the brake pedal 22, at least one intermediate value x, and finally a target current intensity I of a motor current to be supplied to the electric motor 16. However, the cascade sequence in FIG. 1A is to be interpreted only by way of example.

For at least one of the actuating variables 26 defined by the central control unit 10, an output signal 30 is then created by means of a circuit 28 of the central control unit 10 such that the output signal 30 comprises the at least one actuating variable 26. The output signal 30 can in particular comprise all actuating variables 26 defined by the central control unit 10, or all actuating variables 26 defined by the central control unit 10 and considered to be “correct”. The output signal 30 can then be output to the control device 12 by means of the central control unit 10. Preferably, the central control unit 10 and the control device 12 interacting therewith are designed and/or programmed such that the output signal 30 can be/is output from the central control unit 10 to the control device 12 via bus communication. The output signal 30 can therefore in particular be a bus signal.

The at least one actuating signal 26 that is comprised in the output signal 30 can be read out by means of the control device 12. As can be seen from the enlarged representation of the control device 12 in FIG. 1B, the control device 12 can have a circuit 32 by means of which, based on the output signal 30 for the at least one actuating variable 26 comprised therein, the corresponding influence of said circuit on the functions carried out by the control device 12 can be switched. The circuit 32 can therefore be used for the selection of function controls which are carried out by means of the motorized braking, driving and/or steering device 14. Activation or deactivation of functions to be carried out by the motorized braking, driving and/or steering device 14 is thus carried out in accordance with at least one actuating signal 26 comprised in the output signal 30.

In addition, the control device 12 is designed and/or programmed such that at least one actuating signal 26 for the electric motor 16 of the motorized braking, driving and/or steering device 14 can be defined/is defined by means of the control device 12, taking into account the output signal 30, according to the specified cascade sequence. In this way, the at least two actuating signals 26, which are advantageous for controlling the electric motor 16, can be read out and/or defined by means of the control device 12, taking into account the output signal 30. In addition, the design and/or programming of the control device 12 ensures that each actuating signal 26 defined by means of the control device 12 is defined taking into account the at least one preceding actuating signal 26 in the cascade sequence.

Subsequently, at least one motor control signal 34 can be output to the electric motor 16 of the motorized braking, driving and/or steering device 14 by means of the control device 12, taking into account at least one of the read-out and/or defined actuating signals 26 of the cascade sequence. In this way, the electric motor 16 can be reliably and effectively controlled by means of the at least one motor control signal 34 output by the control device 12. The at least one motor control signal 34 output by the control device 12 can be, for example, a motor current supplied to the electric motor 16 with an actual current intensity corresponding to the target current intensity I.

Thus, a so-called system mode management is implemented on the central control unit 10 and on the control device 12 interacting therewith in each case. The at least one actuating signal 26, which is considered relevant/advantageous for open-loop control/closed-loop control of the electric motor 16 by the control device 12, can be dynamically selected as an input signal for the open-loop or closed-loop control function performed by means of the control device 12. This can also be described as the control device 12 being authorized to dynamically “select, from the central control unit 10,” the particular input signal. By means of the “system mode management” of the central control unit 10 and by means of the “system mode management” of the control device 12, the relevant actuating signal 26 can be selected as an input signal in each case for fulfilling a braking, acceleration and/or steering request made by the driver or by the at least one automatic system 24. This achieves an advantageously improved open-loop or closed-loop control strategy compared to the related art.

A particular advantage of the design and/or programming described here of the control apparatus 10 and the at least one control device 12 interacting therewith is that the control apparatus 10 and the control device 12 interacting therewith in each case can use the same software. The amount of work required for programming the central control unit 10 and the at least one control device 12 interacting therewith is therefore comparatively low. Furthermore, the possibility of using the same software for both the central control unit 10 and the at least one interacting control device 12 simplifies so-called FOTA (“flashing over the air”) activities in field operation.

The implementation of the system mode management on the central control unit 10 and the control device 12 interacting therewith also simplifies the transfer of functions between the central control unit 10 and the control device 12. The corresponding functions can optionally be supplied by a supplier of the units 10 and 12, by the vehicle manufacturer itself and/or by another supplier. It is expressly pointed out that a plurality of diverse functions can be implemented as functions on the central control unit 10 and the at least one control device 12.

As an advantageous further development, the control device 12 can also comprise a storage apparatus 36 (only shown schematically). Preferably, in this case, the control device 12 is designed and/or programmed to store each actuating signal 26, read out from the output signal 30 or self-defined, via a parameter on the storage apparatus 36. The storage apparatus 36 is preferably a non-volatile memory.

As an advantageous development, the control device 12 can additionally be designed and/or programmed such that at least one specified monitoring algorithm can be executed by means of the control device 12. Specifically, it can be/is determined, by means of the at least one specified monitoring algorithm, for at least one of the actuating signals 26 read out from the output signal 30 or defined by means of the control device 12, whether the particular actuating signal 26 is a faulty signal. Accordingly, instead of a faulty signal, an actuating signal 26 that is not transmitted via the output signal 30 can also be detected. By means of a corresponding design and/or programming of the control device 12, it can also be ensured that, if the at least one monitoring algorithm determines a number of actuating signals 26 of the cascade sequence as faulty signals and this number is greater than or equal to a specified maximum number, the at least one motor control signal 34 can be/is output to the electric motor 16 of the motorized braking, driving and/or steering device 14 by means of the control device 12, taking into account a specified bridging program. Alternatively, the control device 12 can also be designed and/or programmed to replace (at least temporarily) each signal determined as a faulty signal by means of the at least one monitoring algorithm with a specified substitute signal.

The central control unit 10 and its at least one control device 12 can form a control system for the at least one motorized braking, driving and/or steering device 14 of the vehicle. Alternatively, the control device 12 can also be present as a subunit of the motorized braking, driving and/or steering device 14. However, it should be noted that the design of the control device 12 as a structural subunit of the motorized braking, driving and/or steering device 14 is optional.

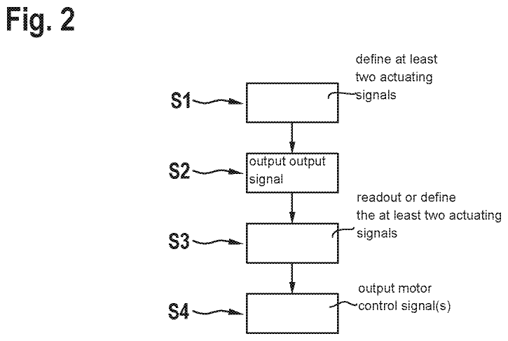

FIG. 2 shows a flowchart for explaining an embodiment of the method for operating at least one motorized braking, driving and/or steering device of a vehicle.

The feasibility of the method described below is not limited to a specific type of the at least one operated motorized braking, driving and/or steering device, or to a specific vehicle type/motor vehicle type of the vehicle/motor vehicle equipped therewith. Examples of the at least one motorized braking, driving and/or steering device have already been listed above.

In a method step S1, at least two actuating signals for an electric motor of the motorized braking, driving and/or steering device are defined by means of a central control unit of the vehicle, according to a specified cascade sequence. The at least two actuating signals are defined taking into account at least one braking, driving and/or steering request signal from at least one sensor of the vehicle and/or at least one automatic system of the vehicle. When executing the method step S1, each actuating signal in the cascade sequence is defined taking into account the at least one braking, driving and/or steering request signal and/or the at least one preceding actuating signal in the cascade sequence. Examples of the at least one actuating signal have already been listed above.

In a subsequent method step S2, an output signal, which comprises at least one of the defined control signals, is output by the central control unit to a control device of the motorized braking, driving and/or steering device. Preferably, the output signal is output from the central control unit to the control device of the motorized braking, driving and/or steering device via bus communication.

Subsequently, in a method step S3, the at least two actuating signals for the electric motor of the motorized braking, driving and/or steering device are read out and/or defined according to the specified cascade sequence, by means of the control device, taking into account the output signal output by the central control unit. When executing method step S3, each actuating signal defined by means of the control device is also defined/determined taking into account the at least one preceding actuating signal in the cascade sequence.

In a further method step S4, at least one motor control signal is output to the electric motor of the motorized braking, driving and/or steering device by means of the control device, taking into account at least one of the read-out and/or defined actuating signals of the cascade sequence. In this way, carrying out the method described here also provides the advantages explained above.

1-10. (canceled)

11. A central control unit configured to interact with at least one control device for at least one motorized braking, driving and/or steering device of a vehicle, wherein the central control unit is configured to:
define at least two actuating signals for an electric motor of the at least one motorized braking, driving and/or steering device, taking into account at least one provided braking, driving and/or steering request signal, from at least one of: at least one sensor of the vehicle, or at least one automatic system of the vehicle, according to a specified cascade sequence, such that each actuating signal in the specified cascade sequence is defined taking into account at least one of: the at least one braking, driving and/or steering request signal, or at least one preceding actuating signal in the specified cascade sequence; and
output to the at least one control device an output signal including at least one of the defined actuating signals.

12. A control device for at least one motorized braking, driving and/or steering device of a vehicle, configured to interact with a central control unit, the central control unit configured to:
define at least two actuating signals for an electric motor of the at least one motorized braking, driving and/or steering device, taking into account at least one provided braking, driving and/or steering request signal, from at least one of: at least one sensor of the vehicle, or at least one automatic system of the vehicle, according to a specified cascade sequence, such that each actuating signal in the specified cascade sequence is defined taking into account at least one of: the at least one braking, driving and/or steering request signal, or at least one preceding actuating signal in the specified cascade sequence, and
output to the control device an output signal including at least one of the defined actuating signals, wherein the control device is configured to:
read out and/or define the at least two actuating signals for the electric motor of the at least one motorized braking, driving and/or steering device, taking into account the output signal output by the central control unit, according to the specified cascade sequence, such that each actuating signal defined using the control device is defined taking into account at least one preceding actuating signal in the specified cascade sequence; and
output at least one motor control signal to the electric motor of the at least one motorized braking, driving and/or steering device, taking into account at least one of the read-out and/or defined actuating signals of the specified cascade sequence.

13. The control device according to claim 12, wherein the control device includes a storage apparatus and is configured to store each actuating signal read out from the output signal or defined using the control device, on the storage apparatus via a parameter.

14. The control device according to claim 12, wherein the control device is configured to execute at least one specified monitoring algorithm, using which the control device can determine whether at least one of the actuating signals read out from the output signal or defined using the control device is a faulty signal.

15. The control device according to claim 14, wherein the control device is configured to, when the at least one specified monitoring algorithm determines a number of actuating signals of the specified cascade sequence as faulty signals and the number is greater than or equal to a predetermined maximum number, output the at least one motor control signal to the electric motor of the at least one motorized braking, driving and/or steering device, taking into account a specified bridging program.

16. The control device according to claim 14, wherein the control device is configured to replace each actuating signal determined as a faulty signal by the at least one specified monitoring algorithm, with a specified substitute signal.

17. A control system for at least one motorized braking, driving and/or steering device of a vehicle, comprising:
a central control unit configured to interact with at least one control device for the at least one motorized braking, driving and/or steering device of the vehicle, wherein the central control unit is configured to:
define at least two actuating signals for an electric motor of the at least one motorized braking, driving and/or steering device, taking into account at least one provided braking, driving and/or steering request signal, from at least one of: at least one sensor of the vehicle, or at least one automatic system of the vehicle, according to a specified cascade sequence, such that each actuating signal in the specified cascade sequence is defined taking into account at least one of: the at least one braking, driving and/or steering request signal, or at least one preceding actuating signal in the specified cascade sequence, and
output to the at least one control device an output signal including at least one of the defined actuating signals; and
at least one control device configured to:
read out and/or define the at least two actuating signals for the electric motor of the at least one motorized braking, driving and/or steering device, taking into account the output signal output by the central control unit, according to the specified cascade sequence, such that each actuating signal defined using the at least one control device is defined taking into account at least one preceding actuating signal in the specified cascade sequence; and
output at least one motor control signal to the electric motor of the at least one motorized braking, driving and/or steering device, taking into account at least one of the read-out and/or defined actuating signals of the specified cascade sequence.

18. A motorized braking, driving and/or steering device for a vehicle, comprising:
a control device configured to interact with a central control unit, the central control unit configured to:
define at least two actuating signals for an electric motor of the motorized braking, driving and/or steering device, taking into account at least one provided braking, driving and/or steering request signal, from at least one of: at least one sensor of the vehicle, or at least one automatic system of the vehicle, according to a specified cascade sequence, such that each actuating signal in the specified cascade sequence is defined taking into account at least one of: the at least one braking, driving and/or steering request signal, or at least one preceding actuating signal in the specified cascade sequence, and
output to the control device an output signal including at least one of the defined actuating signals, wherein the control device is configured to:
read out and/or define the at least two actuating signals for the electric motor of the motorized braking, driving and/or steering device, taking into account the output signal output by the central control unit, according to the specified cascade sequence, such that each actuating signal defined using the control device is defined taking into account at least one preceding actuating signal in the specified cascade sequence; and
output at least one motor control signal to the electric motor of the motorized braking, driving and/or steering device, taking into account at least one of the read-out and/or defined actuating signals of the specified cascade sequence.

19. A method for operating at least one motorized braking, driving and/or steering device of a vehicle, comprising the following steps:
defining, using a central control unit of the vehicle, at least two actuating signals for an electric motor of the at least one motorized braking, driving and/or steering device, taking into account at least one braking, driving and/or steering request signal, from at least one of: at least one sensor of the vehicle, or at least one automatic system of the vehicle, according to a specified cascade sequence, wherein each actuating signal in the specified cascade sequence is defined taking into account at least one of: the at least one braking, driving and/or steering request signal, or at least one preceding actuating signal in the specified cascade sequence;
outputting an output signal including at least one of the defined actuating signals from the central control unit to a control device of the at least one motorized braking, driving and/or steering device;
reading out and/or defining the at least two actuating signals for the electric motor of the at least one motorized braking, driving and/or steering device according to the specified cascade sequence, using the control device, taking into account the output signal output by the central control unit, wherein each actuating signal defined using the control device is defined taking into account at least one preceding actuating signal in the specified cascade sequence; and
outputting at least one motor control signal to the electric motor of the at least one motorized braking, driving and/or steering device using the control device, taking into account at least one of the read-out and/or defined actuating signals of the specified cascade sequence.

20. The method according to claim 19, wherein the output signal is output from the central control unit to the control device of the at least one motorized braking, driving and/or steering device via bus communication.
